(19) United States
(12) Patent Application Publication
(10) Pub. No.: US 2016/0303819 A1
(43) Pub. Date: Oct. 20, 2016

(54) LOAD-BEARING HONEYCOMB STRUCTURES MADE FROM FOLDED MULTILAYER CORRUGATED CARDBOARD

(71) Applicant: Alfred ISELI, Uttwil (CH)

(72) Inventor: Alfred ISELI, Uttwil (CH)

(21) Appl. No.: 15/100,986

(22) PCT Filed: Dec. 3, 2014
(86) PCT No.: PCT/IB2014/002635

§ 371 Date: Jun. 2, 2016

Related U.S. Application Data
(60) Provisional application No. 61/911,001, filed on Dec. 3, 2013.

(51) Int. Cl. B32B 3/12; B32B 37/14; B31D 3/00; B32B 29/08; B32B 7/12; B32B 37/12; B32B 38/00

(52) U.S. Cl. CPC B32B 3/12; B32B 37/12; B32B 37/146; B32B 38/0004; B32B 29/08; B32B 7/12; B31D 3/007; B32B 2405/00

(57) ABSTRACT

The invention relates to weight-bearing honeycomb structures from folded multi-flute corrugated cardboard, and the process and system for the industrial manufacturing of the structures. A load-bearing honeycomb structure is made from a plurality of sheets of folded corrugated cardboard with at least an upper and a lower cover layer. The honeycomb structure includes a length given by the distance between substantially equally spaced cuts through the corrugated cardboard along the direction of flutes, a width given by the width of the cardboard web and by the distance of substantially equally spaced cuts substantially perpendicular to the flutes, and a thickness given by the distance of the substantially equally spaced cuts perpendicular to the flutes.

### CROSS REFERENCE TO RELATED APPLICATIONS

This application claims the benefit of U.S. Provisional Application No. 61/911,001, entitled LOAD SUPPORTING HONEYCOMB STRUCTURES FROM MULTILAYERED FOLDED CORRUGATED PAPER, filed on Dec. 3, 2013, the content of which is incorporated herein by reference and relied upon.

### COPYRIGHT & LEGAL NOTICE

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever which it owns. No license is granted in the works of third parties except as provided under fair use doctrines. Further, no references to third party patents or articles made herein is to be construed as an admission that the present invention is not entitled to antedate such material by virtue of prior invention.

### FIELD OF THE INVENTION

The invention relates to structures, methods and apparatuses for the industrial manufacturing of honeycomb structures from corrugated cardboard with a mechanical stability sufficient for housing construction and other industrial and non-industrial and non-housing uses.

### BACKGROUND OF THE INVENTION

Stacks of corrugated cardboard sheets make up honeycomb plates of excellent mechanical stability when being cut in a direction perpendicular to the flutes of the corrugated medium. Such honeycomb plates have for example been used for the fabrication of pallets of normed size, which are mechanically stable but much lighter than conventional wooden pallets (see, e.g., the International patent application no. WO93/16927 to Iseli, the entire disclosure of which is hereby incorporated by reference).

The extraordinary mechanical stability of such cardboard structures even permits their use in building construction, when the paper base is made fire and water proof by a suitable coating (see for example the German patent application no. DE196 54 672 to Iseli, the entire disclosure of which is hereby incorporated by reference).

One way of producing honeycomb plates from cardboard is to cut endless webs of one-sided corrugated cardboard into rectangular sheets. These sheets, all with parallel directed flutes, are subsequently glued into blocks typically 1.20 to 1.50 m in height. After a certain period of drying of the glue, the honeycomb plates are obtained by cutting the blocks in a direction perpendicular to the flutes, for example by a band saw. This process produces a lot of waste and large amounts of dust. In addition, the honeycomb plates have to be calibrated by grinding. Finally, poor control of the uniformity of the glue results in numerous faulty plates which must be rejected after quality control.

Much more uniform gluing and negligible waste and dust are produced in a roll-to-roll process described in the German patent application no. DE103 05 747 to Iseli, the entire disclosure of which is hereby incorporated by reference. In this process gluing and cutting by razor blades are carried out right at or close to the cardboard manufacturing machine, before the web of one-sided corrugated cardboard is spun onto a hollow drum. Apart from providing uniformity and negligible waste this process eliminates the need for calibrating the honeycomb plates, since the latter can be cut to within a precision of a tenth of a millimeter by the razor blades. Cutting by means of razor blades furthermore prevents the flutes from being squeezed, as frequently happens when ordinary crush cut knives are used. Pressing the flutes onto the cover sheets by excessive mechanical pressure during cutting is highly undesirable since it may lead to nearly closed honeycombs, resulting in heavy loss of the mechanical stability.

PCT/IB2012/002173, to Iseli, the entire disclosure of which is hereby incorporated by reference, teaches the integration of the apparatus for gluing and cutting described in DE103 05 747 into an industrial tool for the production of corrugated cardboard. This tool is suitable for the fabrication of honeycomb rolls with a length of 1.25 to 2.50 m at a typical speed of the cardboard web of 150-400 m/min. Its final product consists either of round or hexagonal plates (honeycombs) with a central hole. It is, however, not possible to fabricate rectangular plates with the tool described in PCT/IB2012/002173.

PCT Appl. no. PWO-I016-003, filed 14 Mar. 2014, to Iseli, the entire disclosure of which is hereby incorporated by reference, teaches the transfer of the production worthiness for round honeycomb plates or wheels proven in PCT/IB2012/002173 to rectangular or quadratic plates. A modification of the process furthermore permits the fabrication of honeycombs of more complicated three-dimensional shape.

EP 1 165 310 to Pflug, the entire disclosure of which is hereby incorporated by reference, teaches a fundamentally different method (FIG. 1, PRIOR ART), limited to the production of rather thin honeycomb plates 3, suitable primarily for paneling and cladding purposes. In this method, a web of single-layered corrugated cardboard 1 is continuously supplied by a cardboard manufacturing machine while being cut into connected strips 2 along the conveying direction 4 and perpendicular to the flutes. The connection between the strips is provided by incompletely cut cover layers. The incomplete cuts are applied alternatively on the top and the bottom cover layer of the corrugated cardboard. Each pair of cardboard strips connected by uncut cover layers is subsequently folded by 180 degrees and the cover layers are glued together. The process results in honeycomb plates, the openings of which are oriented perpendicular to the plates (FIG. 1). The production principle described in EP 1 165 310 implies that the width of the strips mentioned above is roughly the same as the thickness of the corrugated cardboard web. If this condition is exactly fulfilled, the width 6 of the honeycomb 3 created by folding the cover sheets is equal to the width 5 of the original web 1 (FIG. 1). Otherwise, the cardboard strips 2 are subject to undesirable torsion along the length 7. The strips are subject to torsion during the process of folding even when the condition is fulfilled, unless the cardboard web is deformed in a complicated manner in order to avoid changing its width. Torsion of the strips may cause the flutes to develop kinks, lowering the mechanical stability of the honeycomb. The described limitations of EP 1 165 310 imply that the thickness of the honeycombs can deviate only marginally from the thickness of the cardboard web. Taking now into account the height of the waves of just a few mm (e.g., 4-4.9 mm for an A-flute) the strength of the honeycomb becomes correspondingly low, such as to make such honeycombs unsuitable for any applications requiring high mechanical strength such as in load bearing applications in housing component construction.

The purpose of this invention is to provide honeycomb structures, along with methods and apparatuses for their manufacture, which comply with the requirements of weight-bearing elements for building construction. The invention eliminates the limitations of the prior art by providing honeycombs of arbitrary strength, which do not suffer from any undesirable torsion of the strips during folding, even when multi-flute cardboards are used.

It is an advantage of the invention that the length of the honeycomb structures is virtually unlimited, permitting the manufacturing of weight-bearing beams at least (or greater than in one variant of the invention) 8 meter in length.

It is another advantage of the invention that the thickness of the honeycombs can be freely selected to match the desired load-bearing strength. For example a thickness of up to 30 cm may be sufficient for many practical needs in building construction. For example for applications in walls a honeycomb thickness of 65 mm may be optimal.

It is yet a further advantage of the invention that the width of the honeycombs can be made suitable for floors and walls, for example as large as the width of the corrugated cardboard web. Depending on the size of the cardboard manufacturing machine, this width may have an optimal value of 2.50 m, or may for example be as large as 3.60 m or, in another variant of the invention even greater than 3.60 m.

One more advantage of the invention is that the speed of the cardboard manufacturing machine need not be reduced for manufacturing of the weight-bearing honeycombs, thus providing significant manufacturing speed increases.

### SUMMARY OF THE INVENTION

The invention relates to weight-bearing honeycomb structures for housing and other construction made from multiple-flute corrugated cardboard, and to methods and apparatuses for their industrial manufacturing.

### BRIEF DESCRIPTION OF THE DRAWINGS

FIG. 1 is a method known in the art for the fabrication of thin honeycomb structures by cutting and folding single-flute corrugated cardboard.

FIG. 2A is a top view of a multi-flute sheet of corrugated cardboard made up of strips connected by uncut covering layers.

FIG. 2B is a cross-section through a multi-flute sheet of corrugated cardboard with incomplete cuts in a direction perpendicular to the waves.

FIG. 3A is a cross-section of a multi-flute, unfolded sheet of corrugated cardboard.

FIG. 3B is a cross-section through a multi-flute sheet of corrugated cardboard after folding of the uncut covering layers by an angle of about 20 degrees.

FIG. 3C is a cross-section through a multi-flute sheet of corrugated cardboard after folding of the uncut covering layers by an angle of about 140 degrees.

FIG. 3D is a cross-section through a honeycomb made from a multi-flute sheet of corrugated cardboard after folding of the uncut covering layers by an angle of 180 degrees.

FIG. 4A is a top view of a multi-flute sheet of corrugated cardboard cut into strips, top and bottom of the strips alternatingly being connected by various means.

FIG. 4B is a side view of a multi-flute sheet of corrugated cardboard cut into strips, the top and bottom of the strips alternatingly being connected by various means.

FIG. 5A is a longitudinal section through an apparatus for the manufacturing of honeycombs from multiple-flute corrugated cardboard, including cutting, gluing, folding and pressing stations.

FIG. 5B is a top view of an apparatus for the manufacturing of honeycombs from multiple-flute corrugated cardboard, including cutting, gluing, folding and pressing stations.

FIG. 6A is another embodiment of a longitudinal section through an apparatus for the manufacturing of honeycombs from multiple-flute corrugated cardboard, including cutting, gluing, folding and pressing stations.

FIG. 6B is another embodiment of a top view of an apparatus for the manufacturing of honeycombs from multiple-flute corrugated cardboard, including cutting, gluing, folding and pressing stations.

FIG. 7 is another embodiment with a curved honeycomb plate.

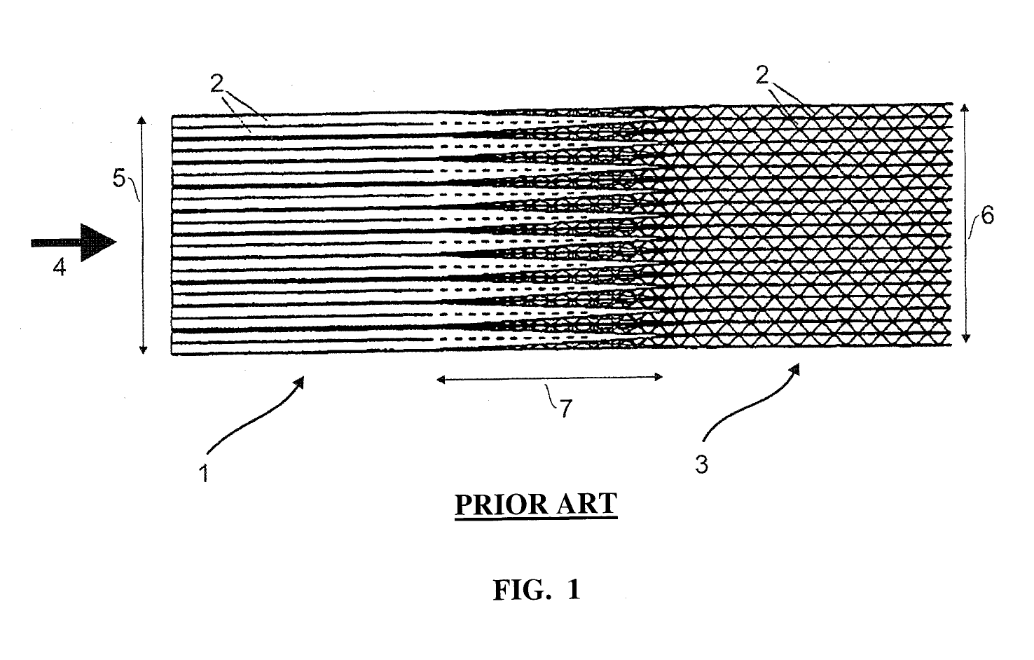

Those skilled in the art will appreciate that elements in the figures are illustrated for simplicity and clarity and have not necessarily been drawn to scale. For example, dimensions may be exaggerated relative to other elements to help improve understanding of the invention and its embodiments. Furthermore, when the terms ‘first’, ‘second’, and the like are used herein, their use is intended for distinguishing between similar elements and not necessarily for describing a sequential or chronological order. Moreover, relative terms like ‘front’, ‘back’, ‘top’ and ‘bottom’, and the like in the Description and/or in the claims are not necessarily used for describing exclusive relative position. Those skilled in the art will therefore understand that such terms may be interchangeable with other terms, and that the embodiments described herein are capable of operating in other orientations than those explicitly illustrated or otherwise described.

### DETAILED DESCRIPTION OF THE PREFERRED EMBODIMENTS

The following description is in no way to limit the scope of the invention. It is of an exemplary nature and designed to describe the best principle of action of the invention as it is known to the inventor at the time of filing of this document.

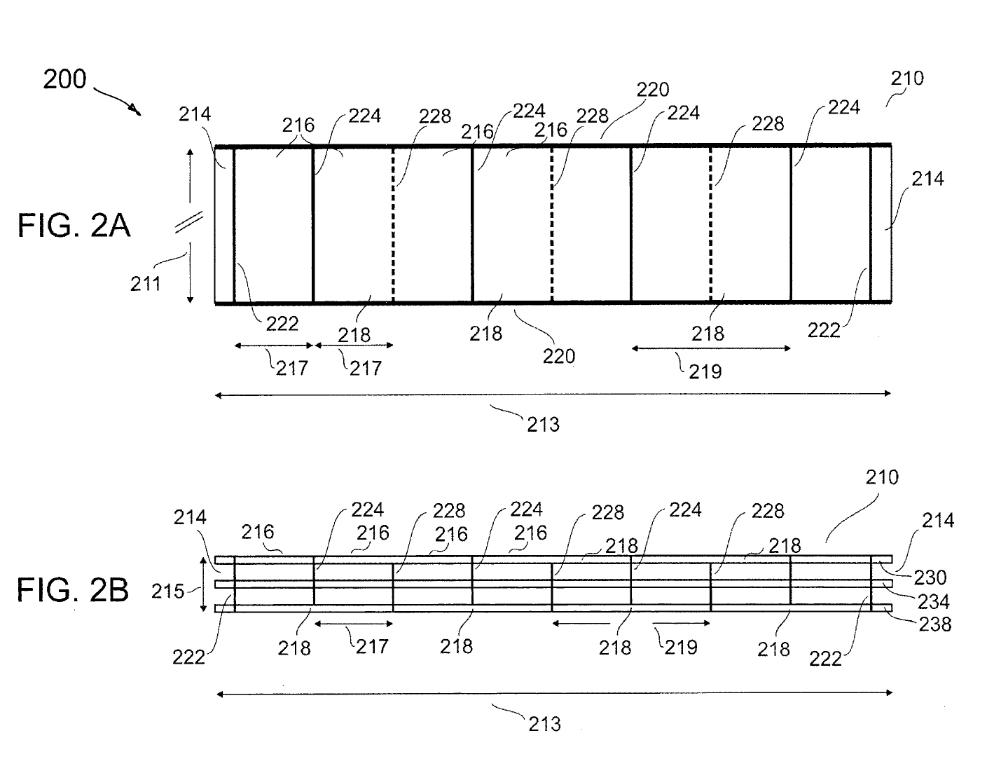

Referring now to FIGS. 2A and 2B, in embodiment 200, a web of single or multiple-flute corrugated cardboard of width 213 and thickness 215, emerging from a cardboard manufacturing machine, is divided into sheets 210 of length 211 by equally spaced cuts 220 perpendicular to the transport direction (or along the flutes). It is most advantageous that the cardboard be of double or triple-flute type. In any case, the cardboard is optimally delivered with at least one upper and one lower cover layer 230, 238 (substantially no exposed waves or corrugations). The width 213 of the cardboard web may amount from 2.50 m to 3.60 m, but widths as small as 1.25 m may be used as well, as well as wider widths, in another variant of the invention. For the fabrication of folded cardboard structures, it is advisable, however, to use a cardboard manufacturing machine of large width, preferably suitable for cardboard webs of width 213 of at least 2.50 m, or in another variant, widths greater than 2.50 m. The length 211 of sheets 210 may for example be chosen to lie between 1.50 m and 4.00 m for large honeycomb plates. For weight supporting beams length 211 may on the other hand be from 1.00 m to as much as 8.00 m or longer.

The subsequent cuts 222, 224 and 228 are directed in the longitudinal transport direction of the web, i.e., perpendicular to the flutes. The cuts 222 through the entire cardboard used for edge trimming produce some waste 214 which is intentionally kept at a minimum. The evenly spaced cuts 224 are applied from above and may be “no through-cuts,” since they may affect only the upper 230 and middle cover layers 234 and leave the lowest cover layer 238 of the corrugated cardboard intact. Similarly, the evenly spaced cuts 228 are applied from below and may neither be through-cuts, since they may leave the uppermost cover layer 230 intact. The spacing between the evenly spaced cuts 222, 224 and 228, i.e., the width 217 of strips 216, has a very high precision not normally obtainable in ordinary cardboard manufacturing. The precision is preferably as high as 1/10 mm with respect to a target dimension. A high precision or tolerance of the cuts is required for the fabrication of honeycombs from folded cardboards of uniform strength. With the exception of the edge trimming 214, the cardboard sheets may consist of connected strips 216 of width 217 held together by uncut strips 218 of cover layers of width 219. Prior to being folded the cut corrugated cardboard sheets are supplied with glue, preferably in such a way that the cuts 224, 228 and the middle of the cover layer strips remain clean of glue.

It is an advantage of the invention that corrugated cardboard of any number of layers (a plurality of layers may be of multi-flute configuration) can be used and that the width 217 of the cardboard strips 216 is freely selectable. This width 217 may, for example, be in the range of 2 cm—30 cm. In other variants of the invention, greater or smaller widths are also created and used. The resulting honeycombs have therefore freely selectable strength 317′. The maximum width of the honeycombs corresponds to the width 213 of the original cardboard web minus the width of the material 214 lost by edge trimming. This maximum width is reached in the case in which the width 217 of the corrugated cardboard strips 216 is equal to the thickness 215 of the cardboard. Wider corrugated cardboard strips result in honeycombs of greater strength, i.e., thickness, which always corresponds to the width 217, 317, 417 of the strips.

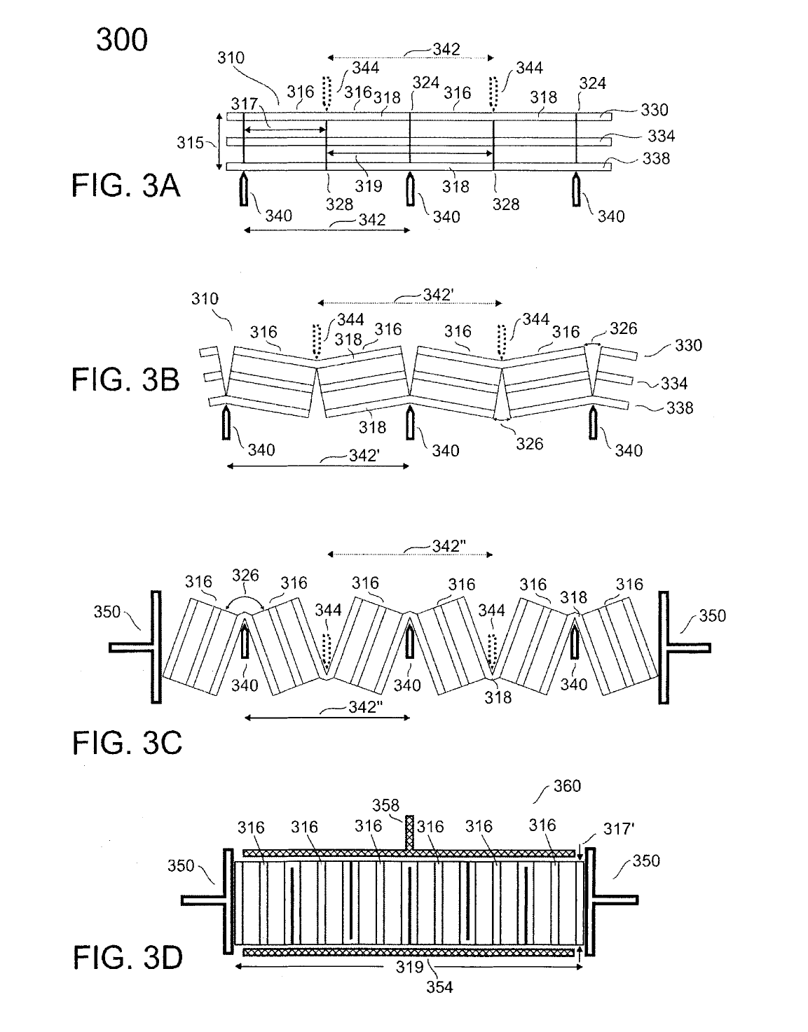

Referring now to the cross-section drawings of FIG. 3A to 3D, a preferred embodiment 300 of the folding of connected cardboard strips 216, after being supplied with glue, requires the steps described below after removal of material 214 stemming from edge trimming. As an example, FIG. 3A shows a cross-section of a double-flute version of a multi-flute corrugated cardboard sheet 310 in its cut, but as yet, planar state. Folding of the strips of uncut cover layers 218, 318 of width 219, 319 is initiated by applying pressure along their middle line or axis in a direction perpendicular to the plane of the cardboard sheet 310. It has been discovered to be advantageous to exert pressure from both sides of the cardboard sheet 310. Downward pressure is exerted by pressure manifold 344 onto the upper cover layer 230, 330 exactly above cuts 228, 328 which leave upper cover layers 230, 330 uncut. Upward pressure is exerted by pressure manifold 340 onto the lower cover layer 238, 338 exactly below cuts 224, 324 which leave lower cover layers 238, 338 uncut. The alternate downward and upward pressure on connected double strips 218, 318 along neighboring cuts therefore results in their alternate upward and downward folding and therefore in cardboard sheets folded in an accordion-like manner. Pressure can be applied by the manifolds 340, 344 for example in the form of pressurized air or mechanically by movable mechanical parts or mechanical assemblies. According to FIG. 3A, the spacing 342 of the pressure points created by the manifolds 340, 344 is identical to the width 319 of the uncut cover layer strips 218, 318. With the beginning of the folding process, the width of the cardboard structure and with it the required distance 342′ between pressure points starts to increase. Accordingly, the distance between the pressure exerting manifolds 340, 344 has to increase as well, in order to guarantee that the pressure continues to be applied along the middle of each uncut cover layer strip 318. In the example of FIG. 3B, the folding angle 326 is approximately 20 degrees. During folding, the maximum width of the cardboard sheet, corresponding to the maximum distance between the pressure exerting manifolds 340, 344, is reached when the tangent of half the folding angle 326 becomes equal to the quotient between the cardboard thickness 215, 315 and the width 217, 317 of the strips 216, 316. For even bigger folding angles, the projected width of the folded cardboard strips decreases again and the distance 342″ between the pressure exerting manifolds 340, 344 has to be lowered accordingly, as schematically shown in FIG. 3C. The pressure device 350 performs the function of exerting horizontal pressure in the plane of the resulting honeycomb 360 as soon as the folding angle 326 has reached a value close to 180 degrees. Warping of the honeycomb during application of pressure device 350 may be prevented by exerting additional pressure in the perpendicular direction by pressure device 358, pressing honeycomb 360 against the flat support 354. At an angle of 180 degrees, the uncut cover layer strips 218, 318 connecting strips 216, 316 have come into intimate contact such that they are firmly glued together, the folding process is completed and the formed honeycomb has a thickness 317′, corresponding to the width 217, 317 of the cardboard strips 216, 316 according to FIG. 3D. Pressure devices 350 and 358 have the role of compacting the honeycomb during curing of the glue and keeping it flat, respectively. The width 319 of the formed honeycomb 360 is equal to the product of the cardboard thickness 215, 315 and the number of cardboard strips 216, 316 participating in the folding process. Apart from the waste 214 due to edge trimming and negligible thickness of the glue, the volume of the honeycomb within the pressure device 350 is identical to the volume of the original sheet of corrugated cardboard 210.

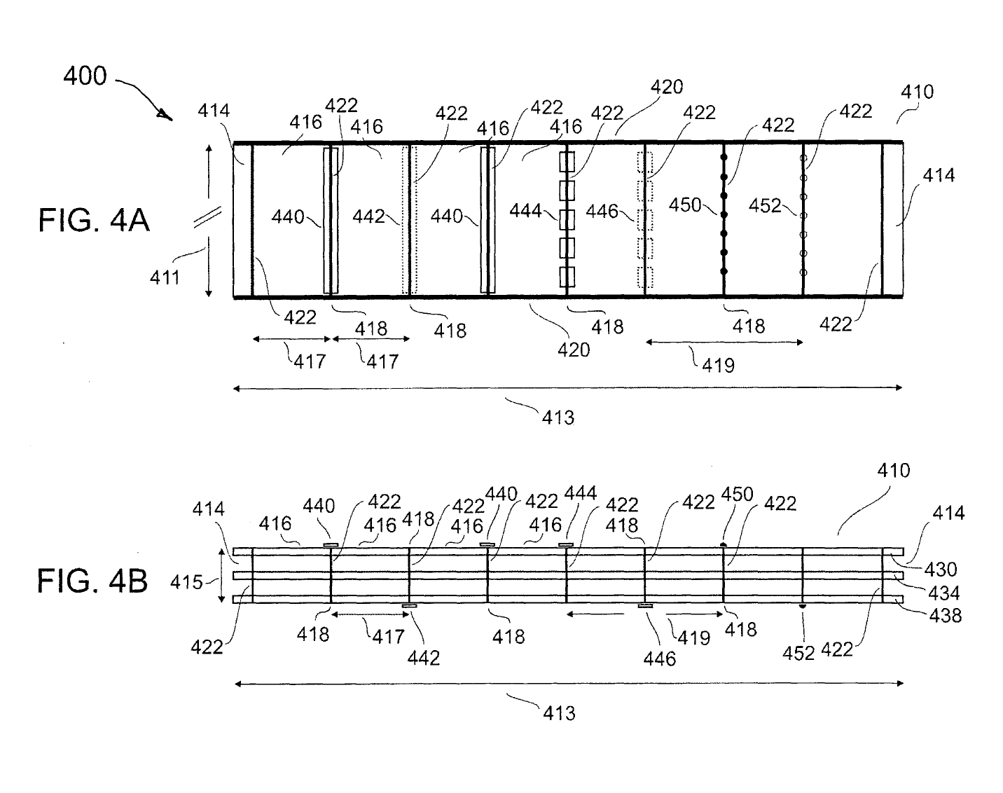

Referring now to FIGS. 4A and 4B, various aspects of embodiment 400 do not require cuts 224, 228, 422 through cardboard sheets 210, 410 to leave the uppermost cover layer 230, 430 and the lowest cover layer 238, 438 alternatingly uncut. By contrast, all cuts 422 are through-cuts similar to the cuts 222 used for edge trimming producing waste 214, 414 and the perpendicular cuts 420, and they may all be formed either from above the corrugated cardboard sheets 210, 410 or from below giving rise to disconnected strips 416 of equal width 417.

There are a number of devices used in the invention which permit the cardboard strips 416, which are no longer connected by partially uncut cover layers 230, 238, 330, 338, to be reconnected and folded in a way similar to that outlined in FIGS. 3A to 3D.

In a first variant of the embodiment, suitable in particular for honeycombs of small width 319 and length 211, 411, the device for reconnecting strips 416 may be a thin foil (e.g., an Aluminum foil) glued onto both sides of the cardboard sheet (onto cover layers 230, 330, 430, 238, 338, 438) for example across its entire length 411 and width 413. Prior to folding, the foils may then be cut for example by ultrasonic actuation similar to the cuts 224, 228, giving rise to double strips 418 of width 219, 419 made up of strips 216, 316, 416, connected by strips of aluminum foil alternatingly glued to the uppermost 430 and the lowest cover layer 438.

In a second variant of the embodiment, the device for reconnecting strips 416 may be a thin adhesive tape 440, 442 alternatingly connecting the upper and the lower cover layer 430, 438 by being placed above cuts 422. Instead of applying tapes along the full length of cuts 422, it may be sufficient to evenly space adhesive labels 444, 446 to permit folding according to FIGS. 3A to 3D. The tapes or labels can be made from a range of suitable materials, for example from paper, woven fabrics, plastic, and so forth. Alternate strips 416 may also be connected by gluing threads across cuts 422, again alternatingly on the uppermost and the lowest cover layer 430 and 438, respectively. In yet another aspect of the embodiment, the device for reconnecting strips 416 may be small drops of fast-drying hot glue 450, 452 evenly spaced above the cuts 422, alternatingly on the uppermost and the lowest cover layer 430 and 438, respectively. All these devices may hence lead again to connected strips 219, 419, which can be folded according to the scheme of FIGS. 3A to 3D, wherein downward pressure may now be exerted by pressure manifold 344 onto the upper cover layer 230, 330 reconnected by devices 440, 444, 450, exactly above cuts 422. Upward pressure may now be exerted by pressure manifold 340 onto the lower cover layer 438 reconnected by the selected devices 442, 446, 452, exactly below cuts 422.

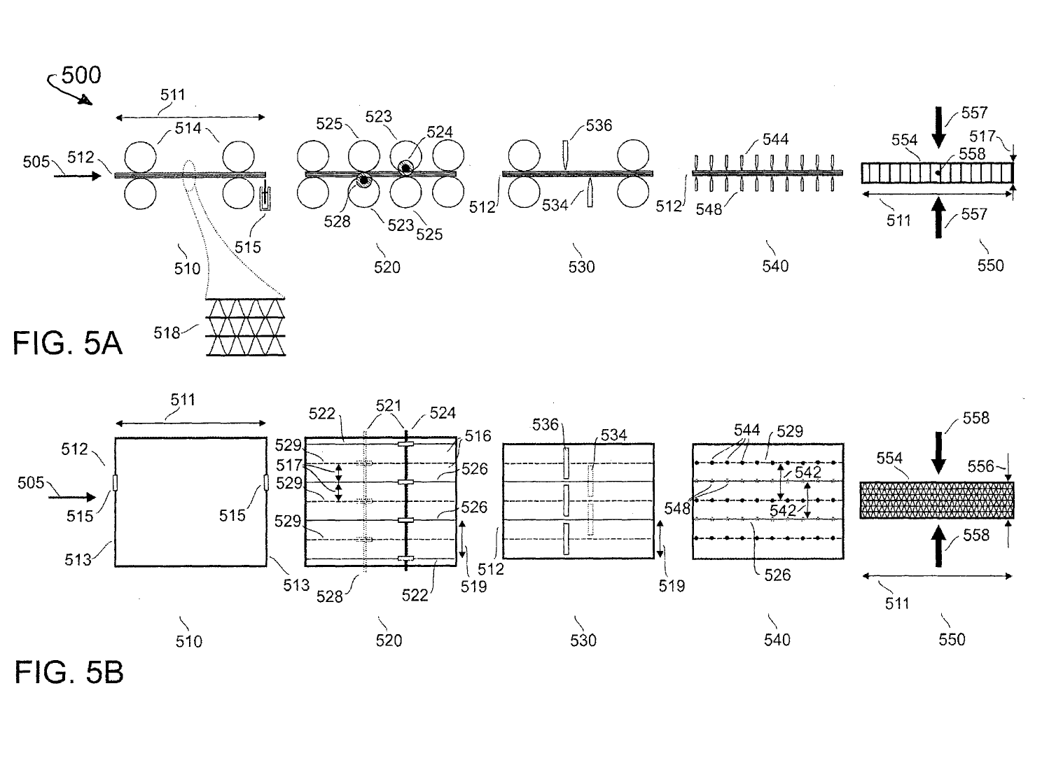

Referring now to FIGS. 5A to 5B, a first embodiment 500 of an apparatus for the production of honeycombs from folded single or multiple-flute corrugated cardboard may comprise five work stations. FIG. 5A is a side view of these five stations, and FIG. 5B is a top view. The five stations are shown for purposes of illustration only, and may be used alone or in combination. They may not necessarily all be performed in the order shown in FIGS. 5A to 5B. In reality, the order of some of the stations may be interchanged, and just the first two stations 510 and 520 may, for example, be located directly at or in the vicinity of a cardboard manufacturing machine, or for example just station 520 alone. The cardboard sheets 210, 410, 512 may, by way of example, be piled up into tall stacks after cutting at one or both of the stations 510, 520, and the stacks may be transported to a separate machine, running at a different speed, equipped for producing the honeycombs by gluing, folding and pressing at stations 530-550. As will be evident to one skilled in the art, placing complicated production steps right at the cardboard manufacturing machine should be avoided so that it can be run at its optimal speed of 100 m/min, or up to 300 m/min or, in other variants, at higher or lower speeds.

In the following illustration of the steps necessary for producing honeycombs from folded corrugated cardboard, the five stations of FIGS. 5A and 5B will be discussed sequentially as if they were indeed part of a single machine or system. At a first station 510, a web of corrugated cardboard coming from a cardboard manufacturing machine or a roll-off device is transported by rolls 514 (only partially shown at the following stations) in the direction 505 and cut by knives 515 along cuts 220, 420, 513 in the perpendicular direction (parallel to the waves or flutes 518) into sheets 512 of length 211, 411, 511. At a second station 520, the cardboard sheets 512 are cut into connected strips 216, 316, 516 of width 217, 417, and 517 by knives 524, 528. Knives 524, 528 are preferably very thin, for example in the range of about 1 to about 1.5 mm, even more preferably about 1.2 mm in thickness, in order not to squeeze the flutes 518 during cutting and to provide clean, straight cuts 522, 526, 529. They are preferably disk-shaped and mounted on a shaft 521, whereon their position and mutual distance can be adjusted precisely to within 0.1 mm either by means of an electronic controller or a mechanical controller. For the production of honeycombs of low strength (corresponding to low thickness), it may be advantageous to use knives 524 mounted on more than one shaft 521 for cutting from above, and similarly for knives 528 for cutting from below. This permits smaller distances 519 between cuts to be achieved although normally it is not possible to space neighboring knives at a distance below about 125 mm. It may be advantageous also to mount brush rolls 525 on either side of the cardboard sheet, opposite to knives 524, 528. These brush rolls may provide a counter force, preventing the cardboard sheet to yield under the pressure exerted by the knives, thereby keeping the cardboard in a constant vertical position and permitting cuts 526, 529 to be executed to a well-defined depth.

Opposite to their cutting side, knives 524, 528 may be provided with grinding tools 523 permitting their continuous sharpening. The diameter of each disk-shaped knife may become slightly different after long cutting periods with uneven grinding. It may therefore be advisable to equip each knife mount with a device for the precise measurement of its diameter. A feedback loop, as known in the art, may then keep the cutting depth of every knife 524, 528 at a preset value.

The connection of the strips may be created and assured in the following way. The knives 524, cutting from above, do not cut through the entire thickness 215, 315, 415 of cardboard sheet 210, 310, 410, 512. Instead, knives 524 produce cuts 526 which only extend through the top 230, 330, 430 and any middle cover layers 234, 334, 434, but not through the lowest cover layer 238, 338, 438. By contrast, knives 528, cutting from below, produce cuts 529 extending only through the lowest cover layer 238, 338, 438 and any middle cover layers 234, 334, 434, while top cover layers 230, 330, 430 remain uncut. The only through-cuts made by knives 524 or 528 are cuts 522 necessary for edge trimming. The partial cuts alternatively made from above and below by knives 524 and 528 result in double-strips 218, 418 of width 519, connected by uncut cover layers 230, 238, 330, 338, 430, 438.

At a third station 530, the cut corrugated cardboard sheets 210, 310, 512 are supplied with glue by gluing device 534 operating from below and gluing device 536 operating from above cardboard sheets 210, 310, 512. Application of the glue by gluing device 534, 536 is preferably made away from the middle of the uncut cover layers connecting double-strips 218, 318, 418 in order to avoid contamination of the mechanical pressure devices 544, 548 operating from above and from below cardboard sheet 210, 310, 512, respectively.

At station 510, the cardboard web may be kept stationary for a short period of time (on the order of seconds) while the perpendicular cuts by knives 515 are being executed. Stations 520 and 530 may, on the other hand, always be operated during through-feed. In order to operate also station 510 under through-feed conditions, it is advantageous to orient the movement of knives 515 to an angle φ with respect to the transport direction 505, such that sin φ is equal to the quotient of the transport speed of the web and the cutting speed of the knives. This mode of operation assures that the cuts 220, 420, 513 are perpendicular to the longitudinal direction of the web, i.e., that the cut cardboard sheets assume rectangular or quadratic shape.

Folding of the cardboard in an accordion-like manner at the fourth station 540 by the pressure exerting manifold 544, 548 is preferably carried out under stationary conditions, as well as pressing of the honeycombs 360, 554 by the pressure devices 557, 558 at the fifth station 550. Pressure device 557 keeps the honeycomb flat, while pressure device 558 is applied during curing of the glue. The folding of stationary corrugated cardboard sheets of finite length 211, 411 into honeycombs of equal length 511 is advantageous, since this process completely avoids any torsion of the strips 216, 316, 516 or, correspondingly, of the cover layers 230, 234, 238, 330, 334, 338, 430, 434, 438 irrespective of the width 217, 317, 417, 517 of the strips and the thickness 215 of the cardboard.

Station 540 comprises pressure manifold 344, 544 positioned to exert downward pressure onto the upper cover layer 230, 330 exactly above cuts 228, 328, 529 which leave upper cover layers 230, 330 uncut and thereby connect strips 216, 316, 516 from above. Upward pressure is exerted by pressure manifold 340, 548 onto the lower cover layer 238, 338 exactly below cuts 224, 324, 526 which leave lower cover layers 238, 338 uncut and thereby connect strips 216, 316, 516 from below. The mechanical pressure devices 544, 548 at station 540 are preferably equipped with a control and feedback mechanism and system which maintains their distance 542 precisely at the required distance 342, 342′, and 342″ at any moment while the folding of the strips is being executed.

Compacting of the final honeycomb 554 of length 511, width 556 and height 517 by pressure device 558 at station 550 provides for curing the glue. In another aspect of the embodiment, stations 540, 550 may be combined to host both the pressure exerting manifold 544, 548 and pressure device 558 as indicated schematically also in FIGS. 3A to 3D.

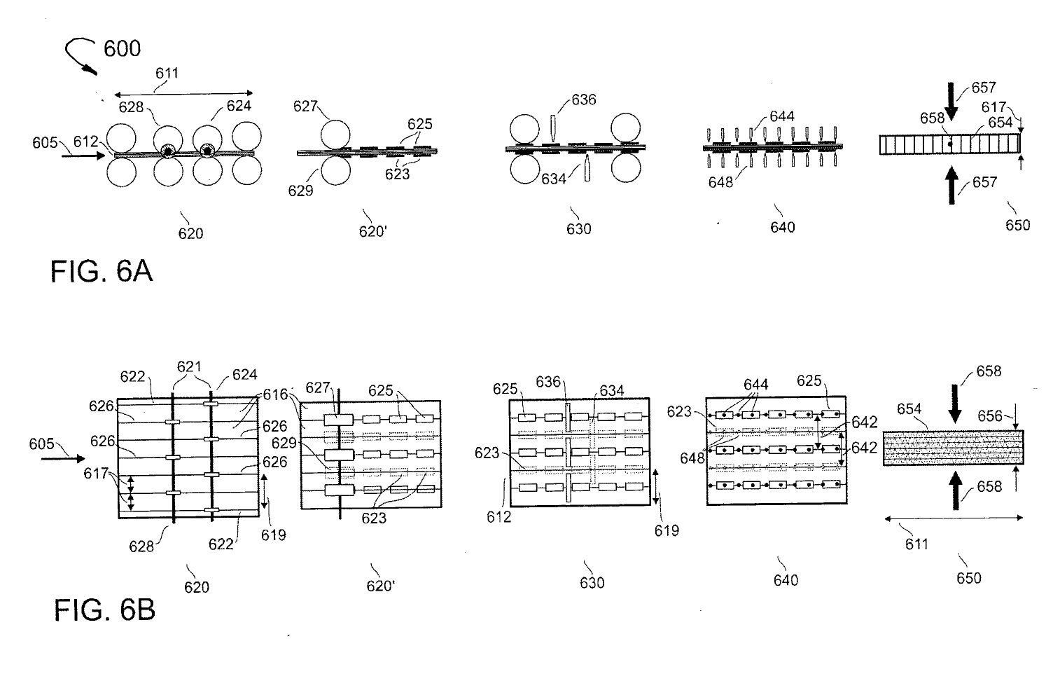

Referring now to FIGS. 6A to 6B, a second embodiment of an apparatus 600 for the production of honeycombs from single or multiple-flute corrugated cardboard may comprise six stations. Again, these six stations do not necessarily all have to be part of the same cardboard manufacturing machine running at its full speed, and can be used alone or in combination. They are depicted for the purposes of illustration only, whereas for the practical implementation of the system similar considerations as for the first embodiment apply. The first station (not shown), at which the cardboard web is cut into sheets 612 of length 611, is identical to station 510 of FIG. 5A. FIG. 6A is a side view of the following five stations and FIG. 6B is a top view. At station 620, knifes 624, 628 may be arranged to cut the cardboard sheets 612 transported in the direction 605 into strips 616 of width 617 for example from the top. Cuts 622 used for edge trimming as well as cuts 626 defining the strips are all through-cuts, leaving strips 616 unconnected by top and bottom cover layers. Knives 624, 628 may be arranged for example in an interdigitated manner on two shafts 621, with a minimum distance 619 of 125 mm along each shaft. In this way, a minimum distance of 65 mm can be realized between neighboring cuts 626, giving rise to strips 616 of similar width. Final honeycombs 360, 654 thus assume thickness 217, 317, 317′, 617 equal to 65 mm in this particular example. Knives 624, 628 are preferably very thin, for example about 1-1.5 mm, even more preferably about 1.2 mm, in order not to squeeze the flutes 518 during cutting and to provide clean, straight cuts 622, 626. They are preferably disk-shaped and mounted on shafts 621 in such a way that their position and mutual distance can be adjusted precisely to within 0.1 mm either by means of an electronic controller or mechanical controller. For the production of honeycombs of low strength (corresponding to low thickness), it may be advantageous to use knives 624, 628 mounted on more than two shafts 621. This permits even smaller distances 619 between cuts to be achieved although normally it is not possible to space neighboring knives at a distance below about 125 mm. It may be advantageous also to mount brush rolls opposite to knives 524, 528. These brush rolls may provide a counter force, preventing the cardboard sheet to yield under the pressure exerted by the knives, thereby keeping the cardboard in a constant vertical position and permitting cuts 626 to be executed to a well-defined constant depth.

Opposite to their cutting side, knives 624, 628 may be provided with grinding tools permitting their continuous sharpening. The diameter of each disk-shaped knife may become slightly different after long cutting periods with uneven grinding. It may therefore be advisable to equip each knife mount with a device for the precise measurement of its diameter. A feedback loop as known in the art may then keep the cutting depth of every knife 624, 628 at a preset value or within a preset range.

Connection between neighboring strips 616 is reestablished at station 620′, for example by adhesive tapes 440, 444, 625 applied from the top and adhesive tapes 442, 446, 623, applied from the bottom of cardboard sheets 612 by appropriate devices 627 and 629, respectively. Strips 616 may also be connected into double-strips of width 619 in any other way described for example in FIGS. 4A and 4B. In an aspect of the embodiment in which the strips are connected by aluminum foils glued to both sides of cardboard sheets 612 at station 620′, an additional cutting station (not shown) similar to station 520 may be used to alternately cut the aluminum foils by cuts 526 from above and cuts 529 from below. This again results in connected double-strips of total width 619, which may subsequently be subjected to folding at folding station 640 after having passed gluing station 630.

At station 630 glue is applied from above by gluing devices 636 which apply glue onto the strips 616 connected on their upper side, for example, by adhesive tapes 625. Similarly, glue is applied from below by gluing devices 634 onto the strips 616 connected from below, for example, by adhesive tapes 623. Note that it is advisable not to apply the glue to cuts 626 which are not covered by adhesive tapes 440, 444, 625 or adhesive tapes 442, 446, 623, in order not to contaminate the mechanical pressure devices 644, 648.

The process of folding of the cardboard sheets in an accordion-like manner at station 640 by pressure exerting manifolds 644 and 648 may be carried out in a way similar to the one at folding station 540. Pressure manifold 644 may be positioned to exert downward pressure onto the upper cover layer 430 reconnected by devices 440, 444, 450, exactly above cuts 422, 626. Upward pressure may be exerted by pressure manifold 648 onto the lower cover layer 438 reconnected by devices 442, 446, 452, exactly below cuts 422, 626. Again, the mechanical pressure devices 644, 648 at station 640 are preferably equipped with a control and feedback mechanism which maintains their distance 642 precisely at the required distance 342, 342′, and 342″ at any moment while the folding of the strips is being executed.

Similarly, the pressing of the final honeycomb 654 of length 611, width 656 and height 617 for compacting and drying of the glue by pressure device 658 at station 650, as well as maintaining the flatness of the honeycomb by pressure device 657, may proceed exactly as at station 550. In another aspect of the embodiment, stations 640, 650 may be combined to host both the pressure exerting manifold 644, 648 and pressure device 658 as indicated schematically also in FIGS. 3A to 3D.

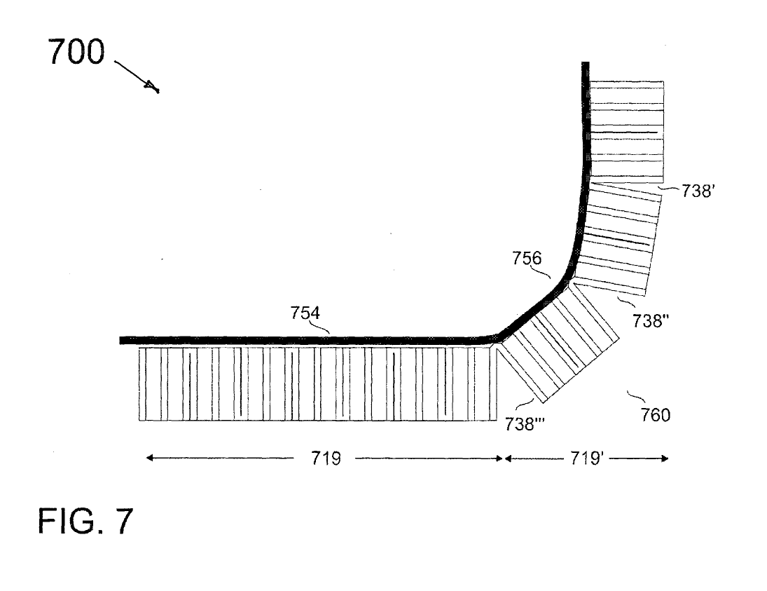

Referring now to FIG. 7, in embodiment 700, folded corrugated cardboard 760 need not be flat but may consist of flat part 719 and curved parts 719′. This may be realized for example by avoiding glue to be applied onto every double strip 218, 318 of uncut cover layers or double strips 418 from reconnected strips 416. In the example of FIG. 7, no glue has been applied onto the uncut lower cover layer strips 738′, 738″, 738″. This permits the honeycomb to be bent when drawn across or pressed against a profile 754, optionally supplied with glue, containing substantially curved sections 756. In this way, for example, brackets or other profiles of honeycombs may be formed. Similarly, honeycombs curved in two directions such that wavy honeycombs arise when the application of glue is omitted alternatingly along a chosen number of double strips 218, 318, 418 connected by uncut or reconnected upper cover layers 230, 330, 430 and a chosen number of double strips 218, 318, 418 connected by uncut or reconnected lower double layers 238, 338, 448.

It should be appreciated that the particular implementations shown and herein described are representative of the invention and its best mode and are not intended to limit the scope of the present invention in any way.

As will be appreciated by skilled artisans, the present invention may be embodied as a system, a device, or a method.

It is an advantage of the invention that weight-bearing honeycomb beams and plates suitable for housing construction with essentially completely freely connectable dimensions can be produced from multi-flute corrugated cardboard directly from a cardboard production machine or from a roll-off device.

It is a further advantage of the invention that the honeycomb beams and plates can be produced with minimal waste due to edge trimming and minimal dust generation.

Benefits, other advantages and solutions mentioned herein are not to be construed as critical, required or essential features or components of any or all the claims.

Moreover, the system contemplates the use, sale and/or distribution of any goods, services or information having similar functionality described herein.

As used herein, the terms “comprises”, “comprising”, or variations thereof, are intended to refer to a non-exclusive listing of elements, such that any apparatus, process, method, article, or composition of the invention that comprises a list of elements, that does not include only those elements recited, but may also include other elements described in the instant specification. Unless otherwise explicitly stated, the use of the term “consisting” or “consisting of” or “consisting essentially of” is not intended to limit the scope of the invention to the enumerated elements named thereafter, unless otherwise indicated. Other combinations and/or modifications of the above-described elements, materials or structures used in the practice of the present invention may be varied or adapted by the skilled artisan to other designs without departing from the general principles of the invention.

The patents and articles mentioned above are hereby incorporated by reference herein, unless otherwise noted, to the extent that the same are not inconsistent with this disclosure.

Other characteristics and modes of execution of the invention are described in the appended claims.

Further, the invention should be considered as comprising all possible combinations of every feature described in the instant specification, appended claims, and/or drawing figures which may be considered new, inventive and industrially applicable.

Copyright may be owned by the Applicant(s) or their assignee and, with respect to express Licensees to third parties of the rights defined in one or more claims herein, no implied license is granted herein to use the invention as defined in the remaining claims. Further, vis-à-vis the public or third parties, no express or implied license is granted to prepare derivative works based on this patent specification, inclusive of the appendix hereto and any computer program comprised therein.

Additional features and functionality of the invention are described in the claims appended hereto. Such claims are hereby incorporated in their entirety by reference thereto in this specification and should be considered as part of the application as filed.

Multiple variations and modifications are possible in the embodiments of the invention described here. Although certain illustrative embodiments of the invention have been shown and described here, a wide range of changes, modifications, and substitutions is contemplated in the foregoing disclosure. While the above description contains many specific details, these should not be construed as limitations on the scope of the invention, but rather exemplify one or another preferred embodiment thereof. In some instances, some features of the present invention may be employed without a corresponding use of the other features. Accordingly, it is appropriate that the foregoing description be construed broadly and understood as being illustrative only, the spirit and scope of the invention being limited only by the claims which ultimately issue in this application.

1. A load-bearing honeycomb structure made from sheets of folded corrugated cardboard strips with at least an upper cover layer and a lower cover layer, the honeycomb structure comprising:
a. a length defined by a distance between first substantially equally spaced cuts through the corrugated cardboard along the direction of flutes,
b. a width substantially given by the product of a thickness of the corrugated cardboard and a number of the folded cardboard strips which are folded together,
c. a thickness given by the distance of the substantially equally spaced cuts oriented substantially perpendicular to the flutes.

2. The structure of claim 1 wherein the corrugated cardboard is at least a double-flute corrugated cardboard with an upper cover layer, a middle cover layer and a lower cover layer.

3. The structure of claim 1 wherein the folded strips have a dimension defined by a distance between the substantially equally spaced cuts oriented substantially perpendicular to the flutes, and wherein pairs of strips of double width are alternatingly folded upwards and downwards along the cuts at an angle of about 160 degrees whereby sheets are folded in a substantially accordion-like manner such that the cover layers supplied with glue are in intimate contact with each other.

4. The structure of claim 1 wherein the second substantially equally spaced cuts perpendicular to the flutes do not extend through both the upper cover layer and the lower cover layer, and wherein the cuts are executed alternatingly from above and from below the cardboard sheet.

5. The structure of claim 1 wherein the substantially equally spaced cuts are oriented perpendicular to the flutes and extend through both the upper cover layer and the lower cover layer, and wherein strips of the upper cover layer and lower cover layer are alternatingly connected by at least one connection selected from a connection selected from the group of connections consisting of:
a. an aluminum foil adhered onto the upper cover layer and the lower cover layer connection;
b. adhesive tapes connection;
c. adhesive label connections made from at least one material, selected from the group comprising a paper material, a woven fabric material and a plastic material;
d. a threads glued across the cuts connection; and,
e. a plurality of drops of fast-drying glue connection.

6. The structure of claim 1, wherein the length of the honeycomb is in the range from about 2 cm to about 30 cm.

7. The structure of claim 1, wherein the length of the honeycomb is in the range from about 1.00 m to about 8.00 m.

8. A process for the production of a load-bearing honeycomb structure, the process comprising the steps of:
a. cutting a multi-flute web of corrugated cardboard having at least an upper cover layer and a lower cover layer into cardboard sheets along flutes at a selected performance speed of a cardboard manufacturing machine, the selected performance speed optionally being a full speed;
b. cutting the cardboard sheets into substantially equally wide strips within a tolerance of about 0.1 mm oriented substantially perpendicular to the flutes at a given performance speed of the cardboard manufacturing machine;
c. applying adhesive to both sides of the cardboard strips;
d. folding connected cover layer strips under substantially stationary conditions alternatingly downwards and upwards by a folding angle of about 180 degrees around axes oriented along the cuts and perpendicular to the flutes, thereby folding the cardboard sheets in a substantially accordion-like manner and bringing the cover layers of adjacent strips into intimate contact for gluing; and,
e. curing the glue under pressure applied to a substantially stationary honeycomb.

9. The process of claim 8, wherein a connection between the strips is established by a connection step, the connection step selected from one or more of the group of connection steps consisting of:
a. alternatingly providing cuts from above and cuts from below to alternatingly leave the lower cover layer and the upper cover layer intact, whereby adjacent strips are connected alternatingly by uncut upper and lower cover layers; and,
b. alternatingly connecting upper cover layer and lower cover layer by at least one alternating connection, the at least one alternating connection selected from one or more of the group of connections consisting of:
i. gluing an aluminum foil onto the upper cover layer and the lower cover layer, and cutting the aluminum foil to alternatively connect the upper and the lower cover layer;
ii. attaching adhesive tapes above the cuts, alternatingly on the upper cover layer and the lower cover layer;
iii. attaching adhesive labels made from at least one material from a list of materials, comprising paper, woven fabrics and plastic alternatingly on the upper and the lower cover layer;
iv. attaching threads across the cuts alternatingly on the upper cover layer and the lower cover layer; and
v. applying drops of fast-drying glue alternatingly on the cuts through the upper cover layer and the lower cover layer.

10. The process of claim 8 wherein the honeycomb has a length between about 2 cm and about 30 cm.

11. A system for the industrial production of weight-bearing honeycomb structures, the system comprising:
a. at least one first apparatus configured to run at a selected speed, preferably an optimal speed, of a cardboard manufacturing machine, the cardboard manufacturing machine producing a web of multi-flute corrugated cardboard with at least one upper cover layer and one lower cover layer; and,
b. at least one second apparatus configured to run at a slower speed for the production of honeycombs from sheets of corrugated cardboard.

12. The system of claim 11, wherein the at least one first apparatus comprises at least one first apparatus station, the at least one first apparatus station selected from one or more of the group of stations consisting of:
a. a station for cutting the web along the flutes into rectangular sheets or quadratic sheets by substantially equally spaced knives;
b. a station for cutting the web substantially perpendicularly to flutes into strips by substantially equally spaced knives; and,
c. a station for substantially precisely stacking the sheets into vertical stacks.

13. The system of claim 11, wherein the at least one second apparatus comprises a second apparatus station, the second apparatus station selected from one or more of the group of stations consisting of:
a. a connecting strip station for connecting the strips into double strips by at least one connecting strip station step, the at least one connecting strip station step selected from one or more of the group of stations consisting of:
i. gluing an aluminum foil onto the upper cover layer and the lower cover layer, and cutting the aluminum foil to alternatively connect the upper cover layer and the lower cover layer;
ii. attaching adhesive tapes above the cuts, alternatingly on the upper cover layer and the lower cover layer;
iii. attaching adhesive labels made from at least one adhesive label material, the at least one adhesive label material selected from the group of label materials consisting of a paper material, a woven fabric material, and a plastic material, alternatingly on the upper cover layer and the lower cover layer;
iv. attaching threads across the cuts alternatingly on the upper cover layer and the lower cover layer; and,
v. applying drops of fast-drying glue alternatingly on the cuts through the upper and the lower cover layer; and,
b. a gluing device station comprising a first gluing device arranged above the upper cover layer and a second gluing device arranged below the lower cover layer to alternatingly apply glue on the upper cover layer and the lower cover layer connecting the cardboard strips;
c. a stationary station comprising: a pressure exerting manifold to exert downward pressure on connected strips of the upper cover layer along cuts and upward pressure on connected strips of the lower cover layer along cuts with a control and feedback mechanism maintaining distance between one or more pressure manifolds precisely at the distance required to fold connected cover layers alternatingly downward and upward through a folding angle of about 180 degrees thereby folding cardboard sheets in a substantially accordion-like manner and bringing the cover layers of adjacent strips into intimate contact for gluing; and,
d. a stationary pressing station for compacting the honeycomb and curing of glue.

14. The system of claim 12, wherein the station for cutting the web into strips comprises at least one web strip cutting device, the at least one web strip cutting device selected from one or more of the group of devices consisting of:
a. a device for precisely adjusting the distance between the knives to within a tolerance of 0.1 mm;
b. a device for maintaining the cardboard in a constant vertical position by providing a counter three to the force exerted by the knives;
c. a device for continuous sharpening of the knives; and,
d. a device for continuously monitoring and adjusting the cutting depth of the knives.

15. The system of claim 11, wherein the honeycombs are manufactured to have a length and or width in the range from about 2 cm to about 30 cm.

16. The system of claim 11, wherein the honeycombs are manufactured to have a length in the range from about 1.00 m to about 8.00 m.
